(19) United States
(12) Patent Application Publication
(10) Pub. No.: US 2024/0345277 A1
(43) Pub. Date: Oct. 17, 2024

(54) Cenotaph Spectroscope, an Apparatus for Dual Solar Optics and Geo-Resonance Imaging

(71) Applicant: Farzeen Binte Farooq, Austin, TX (US)

(72) Inventor: Farzeen Binte Farooq, Austin, TX (US)

(21) Appl. No.: 18/135,171

(22) Filed: Apr. 16, 2023

(51) Int. Cl. G01V 3/14; G02B 17/08; G02F 1/11; H04N 23/80; H04N 25/71

(52) U.S. Cl. CPC G01V 3/14; G02B 17/08; G02F 1/11; H04N 23/80; H04N 25/71

(57) ABSTRACT

A cenotaph optical device absorbing UV light beams in high-intense thermal pressure, dynamic and alternating optical glass trap situated beneath each transform to collect uniform colluded radical ions, preventing further light decay, thus further reducing chromatic aberration. A wireless RFOF optical network cross linked with one convex aperture lens, one viewing aspheric lens, a programmable SoC to serve as an aspheric corrector, two concave lenses, having incorporated therein a cobalt-infused fiber-optic filament wherein the potent filtration ion is Zr⁴⁺ or Ti⁴⁺. The inventive device is optically clear and can be utilized to cast microporous films over altered barometric pressure, either supported or unsupported. The catadioptric optical device of which this invention's dual optical system relates combines lenses and mirrors to form discernible images as a direct proportionate of chromatic aberration, wherein images are sequential and static as a result of thermal induction throughout a series and combinations of lenses and mirrors. Under extreme temperatures, coating on its components adsorb subsurface material at various stages of the IR and UV spectra, permitting the apparatus to act with a sub compartmentalized cryopanel, initiating photons. This enables deep space detection. The purpose of which is to view distant celestial bodies at the subsurface phase in motion, while maintaining cost-effective integrity and portability.

### FIELD OF INVENTION

The present invention relates to an optical rod lens, an optics mirror, a cryomodular cavity, a radio frequency-over-fiber (RFoF) component, a digital SoC, and a composite objective lens structure.

### CITATION LIST

US 2023/11604289 B2
US 2023/11733552 B2

### SUMMARY OF THE INVENTION

A first aspect according to the present invention is an optical rod lens employing neutron diffraction of long-range antiferromagnetic resonances by mass %, 30% to 55% of a content rate of Zr⁴⁺—Ti⁴⁺ alloy, and 20% to 50% of a content rate TiO₂ wherein a ratio of the content rate of TiO₂ to a content rate of Zr⁴⁺—Ti⁴⁺ alloy is 0.15 to 0.75.

According to the present invention, a second aspect is an optical element using the optical rod lens described above.

A third aspect of the present invention is a dual optics system including the optical element described above.

According to the present invention, a fourth aspect is an oscillating acousto-optic modulator including the dual optical system and the optical element described above.

A fifth aspect according to the present invention is an objective off-axis ellipsoidal mirror, having <100 A including the acousto-optic modulator including the dual optics system including the optical element described above.

A sixth aspect according to the present invention is a system-on-a-chip board with broadband dielectric resonance including the dual optics system including the optical element described above.

A seventh aspect according to the present invention is a de-ionizer including the system-on-a-chip board including the dual optics system including the optical element described above.

An eighth aspect according to the present invention is a cryomodule encasing a second optical rod lens element with the first off-axis ellipsoidal mirror element, and at least one of any optical rod lens is coated in gold including the system-on-a-chip board including the dual optics system including the optical element, and at least one of the optical rod lens is the optical rod lens described above.

A ninth aspect according to the present invention is an objective lens including the cryomodule including the system-on-a-chip (SoC, hereinafter) board including the dual optics system as described above.

A tenth aspect according to the present invention is a graphene Fourier transform including the de-ionizer including the system-on-a-chip board including the dual optics system including the optical element described above.

An eleventh aspect according to the present invention is a cobalt filament transmitter including the objective lens including the cyromodule including the system-on-a-chip board including the dual optics system.

A twelfth aspect according to the present invention is an aspheric corrector including the cobalt transmitter including the de-ionizer including the system on-a-chip board including the dual optics system.

A thirteenth aspect according to the present invention is an Hg²⁺ pressure cradle including the dual optics system described above.

### DETAILED SUMMARY OF THE INVENTION

The catadioptric optical device of which this invention's dual optical system relates combines lenses and mirrors to form discernible images as a direct proportionate of chromatic aberration, further found to result as the percent acquisition accumulated in a sample of subsurface material emitting light as a factor of its magnification of view over sequentially elliptical optical trajectories, found in its natural state in degrees of 2 r,′ 4 r,′ 7 r,′ 13 r,′ and 19 r;′ wherein r′ is the unit molar gas demarcated by atomic mass units. Such demarcation has been visibly detected by the naked eye at distortion half-angular levels of the determinate reflection belonging to training images causing residual effect indicating spatial deterioration.

The inventive Cenotaph Spectroscope is primed for construction by first splicing and coiling 5 bundles of 23 optical fibers held in mechanical form by 8 crystal silicon ingots approximating 3 mm each. Each coil is, then positioned radially throughout the length of the inventive apparatus. The RFOF hybrid optical network to which this invention's construct relates is attained by means of a stacking component wherein geo-resonance detection is achieved by means of aperture design and utilizing the CR3BP formula.

The optical rod lens aperture to which this invention's dual optical system relates traverses through the body through which a spatial modulator articulates variations in angular oscillations by means of a coated objective lens, two optics rod lenses, an off-axis ellipsoidal mirror, and a graphene fourier transform. Partial to the present invention's dual optical system, six spherical chromatic lenses, a base rotating optical glass, and two bilaterally affixed card slots hold an integrated SoC board and connect the SoC board to a cobalt filament and Hg²⁺ pressure cradle. In combination with a cryomodular cavity with a series of five cryopanels, a mobile de-ionizer, a carbon-fiber extraction coil, and an external aperture lens structure, a coronagraphic plate is formed and articulates with the above-mentioned cross-gradient transforms, thus filtering FT/IR residue and computing an adsorbent ratio by molar equilibrium.

According to the preferred embodiment, the stacked optical axes tilt with respect to each complementary inflection point within the residual and elemental stream of cationic mercury; while deflection points maintain transparency computed by measuring the upstream velocity of anionic mercury by means of filtration, the preferred angle of refraction is measured to 27° for both close- and distant-viewing capacities. Pressure differentiation becomes innately dependent upon mercury's adsorption and consequently, the oxidation rate resulting from uniform synergistic hydrogen bonding between mercury and cobalt, measured by modulating entropic factors and integrating such factors as instructions to control negative space matrices programmed within the SoC board. SoC board differentiation is programmed, thus, through sensor-based filtration by means of an interconnected resistor and transistor chamber. Electricity in dual transmittance is, thus, distributed equally. Subsurface material adsorption is achieved by measuring pressure at any point inside a fluid with enough velocity to balance a fixed flow of fluid attributing dispersed weights when regulated by concentrated bearings, proving to function as a combined reticule between dispersion chambers and the light source.

Omnidirectional motion is honed and utilized to capture 360° field of view magnifications and is only newly introduced to the field of astronomy and space exploration. Liquid mercury as an inner reflection barrier is essential to this invention due to its causal relationship with the earth's overall gravitational field. An embodiment of the present disclosure relates to an external cobalt tubing coiled around an optical glass lens to conserve surface area and act as a cobalt-based sorbent enhancing mercury's absorption rate, thus allowing liquid mercury within a confined space to adsorb to the surface of a carbon-based sorbent catalyst to further react with lattice oxygen molecules. This is known as a synergistic hydrogen bonding network and occurs in the most highly concentrated surface areas of differentiated air pressure. This is the inner removal of liquid mercury and creates thermally induced native pressure within a porous medium, through which the hollow optic glass rod is the preferred embodiment, and herewith referred to as the “primary switch.”

### DESCRIPTION OF EMBODIMENTS

Hereinafter, a description is made of an embodiment of the present invention (hereinafter, referred to as the “present embodiment”). The present embodiment described below is an example of describing the present invention and is not intended to limit the present invention to the contents described below.

In the present specification, a content rate of each of all elements is expressed with mass % with respect to the accumulated weight of glass in terms of an oxide-converted composition, unless otherwise stated.

An expression that a Q content rate is “0% to Y %” is an expression including trials where the Q component is implemented with trials where the Q component is less than 2%.

An expression that a “Q component is not included” means that the Q component is not substantially included and that the content rate of the constituent component is an impurity level of less.

The optical rod lens according to the present embodiment can have low dispersion, great abbe number, and can have a high partial dispersion ratio. Thus, a light-weighted lens with a deep focal length in aberration correction can be achieved.

An abbe number (v_{d}) of the optical rod lens according to the present embodiment falls within a range from 20 to 32. A lower limit of the abbe number is preferably 22. An upper limit of the abbe number is preferably 31.

The cobalt coiling according to the present invention can have conducive factors in articulation with any of the two aforementioned optical rod lenses to permit mercury in its liquid state to catalyze in the presence of lattice oxide compounds. In general, ultrashort pulse light emitted from the cobalt transmitter component is linearly polarized light, polarizable in a preset magnitude.

Synergistic hydrogen bonding networks by the present invention is an optionable catalyst that occurs in the most highly concentrated surface areas of differentiated air pressure and increases catalysis of Hg²⁺, liquid mercury, and induces expulsion of native atmospheric pressure within any porous medium, preferable to articulation with hollow optic glass, including the aforementioned optical rod lens.

TiO₂ is a component that increases a refractive index and a partial dispersion ratio and reduces transmittance. When the content rate of TiO₂ is reduced, the refractive index and a partial dispersion ratio are apt to decrease. At the time the rate of TiO₂ is excessively increased, a transmittance is liable to be degraded. The content rate of TiO₂ is from 10% to 45%. A lower limit of this content rate is preferably 12%. An upper limit of this content rate is preferably 40%.

The exterior body according to the present invention includes an inner two-layered silicon tube that when adhered to the aforementioned optical rod lens can be positioned radially with ingots and wafers, increasing encapsulation within a nickel or aluminum frame, underneath which surface tensions permit radial placement of graphene grafts at opposing terminals of the exterior body, further maximizing emitted polarized light to remain uniform in saturated pressure for modulation.

A liquid metal bridge by the present invention is dependent on the velocity of Hg²⁺ in the presence of a paramagnetic field, an enabling element by means of differentiated surface tension. Thus, the liquid metal bridge must be positioned beneath the imaging sensor.

By the present invention, the imaging sensor, an optical element, can be affixed port to a SoC board, aft to the ocular eyepiece, and superior to the base of the dual optics system. The imaging sensor by relation can be positioned at the superior terminal by the present invention and affixed to the liquid metal bridge at its cathode to induce adsorption, a component of the system-on-chip board encompassing a solar converter component.

A solar converter chip provides efficiency in transforming sunlight into electricity, wherein electric discharge is diffused through pressure chambers by the molar gas concentration constant over kinetic energy, regulated within the modulated structure, therein simultaneously filtered by the aforementioned SoC board and capsid and the aforementioned dual optical system in combination. Thus, this combination is accomplished by means of the elemental mercury liquid pressure attainable by means of a digital switch, positioned onto an optical rod laser, forming a mirror-to-lens arrangement with a graphene base acquiring prismatic properties.

The off-axis ellipsoidal mirror by the present invention is stereo-metric having pointing capability by maintaining alignment between the first optical rod lens and the second optical rod lens to form a tracking system, directing an optical signal to impinge on a target, thus, superimposing the optical signal over a specific magnitude exterior to the device body in a current celestial topographical layout.

By the present invention, the solar panel of graphene fourier transform includes a reflective film stretched within influx points of the carbon fiber frame and suspended by means of alternating ingot/wafer arrangements. Positioned at its core, the solar panel colloids into a concentrated plaque affixed by nanotubule struts, forming a nanoelectromechanical system at each influx point across the body tube.

### BRIEF DESCRIPTION OF DRAWINGS

FIG. 1 is a perspective schematic diagram illustration of an optical device according to the present invention embodiment as an imaging device and tracking device. The first component of the dual optics system is the compact rod [1] includes, as a base material, an optical element including an optical rod glass according to the present embodiment. A central cartridge is mounted to a lens mount (not illustrated) of a laterally positioned optical column that is dielectric in a removable manner. An image is formed by passing light through the compact optical rod [1] and the central cartridge [10], on a sensor system-on-a-chip board [11](SSD elements), such as in a COG-type module including a sensor chip, respectively for imaging. A cobalt transmitter with a cobalt filament component [2] emits pulse light having a near-infrared wavelength (approximately 1,000 nm) and a pulse width of a picosecond unit. An imaging sensor unit [3] will integrate the refractive indices of each wavelength detected; with a cryomodule [4] consisting of liquid carbon dioxide (CO₂), the imaging sensor unit [3] differentiates air pressure in flux with each cyropanel [5] to produce oscillation within cryomodule component, refracting light at reduced frequencies. The second component of a dual optical system initiates with a laterally positioned optical column [9]. In juxtaposition to SoC [11], an off-axis de-ionizer [12], an enclosure consists of a Hg²⁺-resonance cartridge [10]. This position increases not only the durability of the device but also increases the SoC conversion rates, thus the device's magnification capacity. In communication with dual optical systems one and two, a liquid barrier formed by the articulation of the solar panel [6], cross-planar graphene transform [7], stereo-metric mirror [8], and varying gallium conductors [13], directly tracks infra-red emittance from an ocular foci, generating the reverse image within the above-mentioned gold-coated second optical rod lens and off-axis ellipsoidal mirror (stereo-metric). In conjunction with an oscillating cryomodular cavity, the accumulation of paramagnetism is increased tenfold.

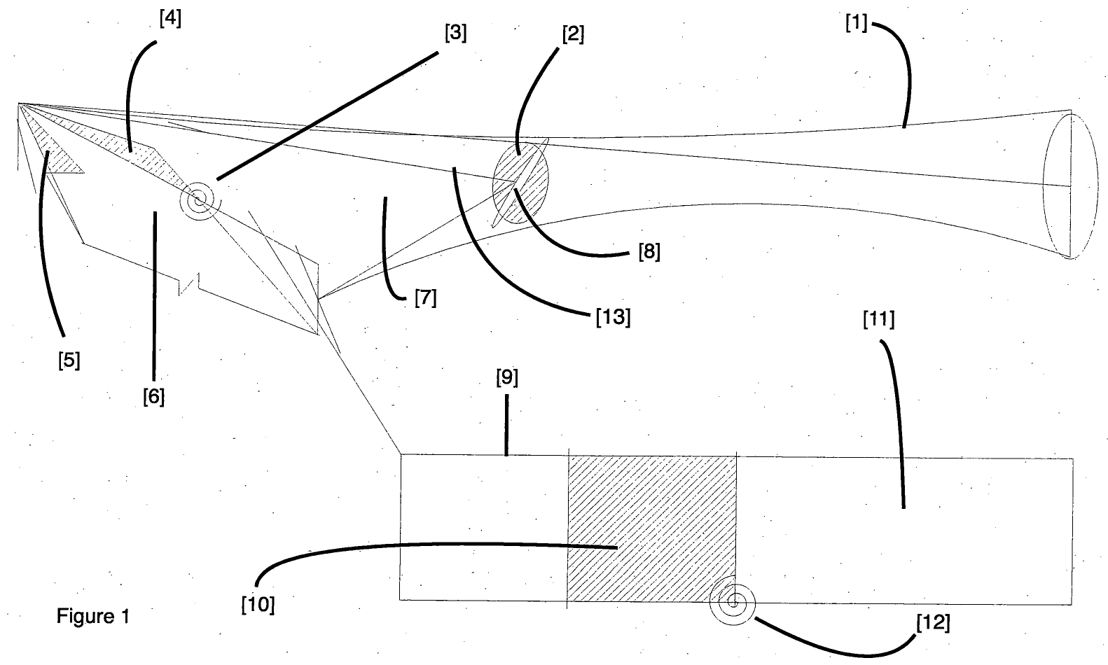

FIG. 2 is a technical blueprint of a system-on-a-chip with a central processing unit and graphics processing unit to render a three-dimensional layout of terrain data from a distance using an integrated polar-coordinate scheme. The boundaries are hereby selected by articulation from a receiver to a nano processing unit [14], and processed in a zinc and nickel alloy reservoir coated in liquid carbon dioxide with conductive contacts that acts as a access device, monitored by power management locale [17], or a reserved region within the board's confined area. Resonance data is then transmitted from the reservoir to the RAM driver circuitry and the Flash driver circuitry that acts as a storage node device by means of a transmitter for compounding. The central processing unit is terminated at an embedded nano processor (64-bit) by means of a localized oscillator circuit in parallel articulation to an embedded lithium-ion battery [18]. To construe a memory device, in further articulation with the embedded nano processor are the graphics processing unit [20], display [23], and aforementioned receiver [21].

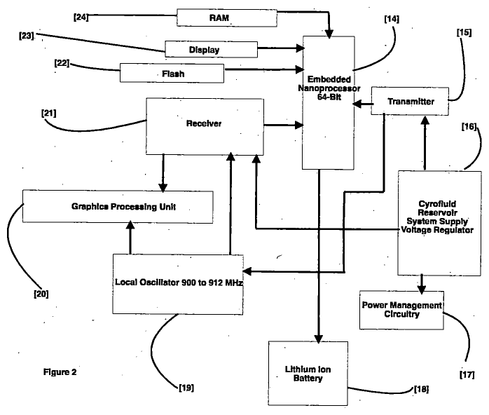

What is claimed:

1. A catadioptric structure to detect geospatial resonances through the use of an optics mirror and sequential optical lens to spatially detect, image, and track electrostatic sub-atomic particulate comprising:
an optical rod lens of 0.762 m to be fitted in a telescope said rod lens having a rod-shaped body made at least in a section thereof of a flexible, transparent solid piece of plastic material;
an acousto-optic modulator including a first acousto-optic oscillator when a first ultrasonic wave is applied and a second acousto-optic modulator to diffract a higher order beam output from the first acousto-optic modulator when a second ultrasonic wave is applied, a propagation direction of the first ultrasonic wave relative to a diffracted direction of a higher order beam emitted from the first acousto-optic modulator and a propagation direction of the second ultrasonic wave relative to a diffracted direction of a higher order beam emitted from the second acousto-optic modulator differentiating a frequency shift caused by the first acousto-optic modulator and a frequency shift that is caused by the second acousto-optic modulator to cancel each other out;
a RFOF coil including a Zr⁴⁺—Ti⁴⁺ alloy plate to catalyze Hg in liquid form with Co³⁺ cation when a differentiated air pressure vortex is conducted and emitted throughout;
a de-ionizer to remove Mercury Hg²⁺ cations from any of F—, OH—, Cl— anions;

2. The catadioptric structure of claim 1 wherein said acousto-optic modulator has at least one cryomodular cavity encasing four cryomodular panels affixed occidental optical rod lens to adsorb photoisomerized ions following photoexcitation of Hg²⁺ producing a magnetic resonance signature across said RFOF coil by means of cryogenic solvents, preferred Liquid Carbon Dioxide CO₂, thereby integrating modulation that's concurrently articulating with any Hg-Liquid pressure stream to determine electro-optic properties.

3. The catadioptric structure of claim 1 wherein said RFOF coil connects a monolithic aperture with extending 130-degree field of view by means of one convex lens and one optics mirror positioned at mid-section of said optical rod lens.

4. The catadioptric structure of claim 1 wherein said de-ionizer is saturated in any photoactivatable vibrational probe with high-precision spatial and temporal control to bind to the electrostatic moiety.

5. A system on-a-chip board including a base silicon bare die and a freon solar cell to increase field of magnification when random focal points coincide with one digitally detectable pressure point comprising:
a digital CCD imaging sensor to transmit anions emitted from unique magnetic resonance signatures;
a Cubic Zirconia microlens central processing unit to process electrostatic signals detectable up across unique magnetic resonances and act as DSP;
a Titanium refraction graphics processing unit to accelerate said acousto-optic modulator, furthering image uptake by means of oscillating wavelengths across magnetic resonance spectra;

6. The system on-a-chip board of claim 5 wherein digital CCD imaging sensor is coupled with exposure to polarized electrical current by means of one Cubic Zirconia microlens resistor and four titanium-coated digitally refracted transistors.

7. The system on-a-chip board of claim 5 wherein said cubic zirconia microlens central processing unit encases five transistors and four resistors to sequentially monitor and limit the flow of oscillating electrostatic energy.
